(19) United States
(12) Patent Application Publication
(10) Pub. No.: US 2019/0054915 A1
(43) Pub. Date: Feb. 21, 2019

(54) Service Brake Assist Steering

(71) Applicant: Deere & Company, Moline, IL (US)

(72) Inventors: James T. Noonan, Ankeny, IA (US); Steven D. Wallestad, Ankeny, IA (US); Jerry E. White, Ankeny, IA (US); Dwayne B. Watt, Bartlesville, OK (US); Kevin J. Goering, Ankeny, IA (US)

(21) Appl. No.: 15/678,731

(22) Filed: Aug. 16, 2017

(51) Int. Cl. B60W 30/045; B60W 10/18; B60W 10/20; B60W 50/00; B60T 7/04; B60T 7/12; B60T 8/175; B60T 8/1755; B60T 8/72; B60T 13/66; B60T 13/68

(52) U.S. Cl. CPC B60W 30/045; B60Y 2200/222; B60W 10/20; B60W 50/0098; B60T 7/04; B60T 7/12; B60T 8/175; B60T 8/1755; B60T 8/72; B60T 13/662; B60T 13/686; B60W 2050/0026; B60W 2510/20; B60W 2520/10; B60W 2550/12; B60W 2520/26; B60W 2710/207; B60W 2710/182; B60T 2270/311; B60W 10/18

(57) ABSTRACT

A brake assist system is disclosed for assisting the steering operations of a mobile vehicle. The brake assist system comprises a service brake assembly having a first brake device and a second brake device and an auxiliary control assembly coupled to the service brake assembly. An electronic control unit is communicatively coupled to the auxiliary control assembly and configured to receive an input signal indicative of a vehicle operating parameter comprising at least one of a steering angle generated by a vehicle guidance system or a vehicle speed error and generates a control signal to activate the main and secondary valve circuits by proportionally controlling an output of at least two control valves arranged in the main and secondary valve circuits to supply a pressurized flow of fluid is applied to at least one of the first or second brake devices to assist steering operations of the vehicle.

### FIELD OF THE DISCLOSURE

The present disclosure relates generally to generally relates to brake assist systems and, more particularly, to a system and method for automatically applying service brakes to assist with the steering operations of a mobile vehicle.

### BACKGROUND OF THE DISCLOSURE

During the operation of tracked or untracked vehicles, the application of the vehicle brake system to assist steering operations is often desirable. For example, in inclement weather conditions, vehicle steering operations may become difficult, thereby leading to improper alignment and positioning of an operating vehicle, which, in turn, may require frequent application of the vehicle service brakes to maintain good steering control. Additionally, under such conditions, it is also difficult to increase vehicle speed while maintaining appropriate machine guidance.

To address such concerns, some conventional approaches employ the use of propel hydrostatic relief valves and engine braking to support panic stopping to meet standard requirements. Drawbacks to such approaches, however, include increased engine over-speeds. As such, there is a need in the art for an improved service brake system to assist with vehicle steering that is low cost, limits engine over-speed during a panic stop situation, and provides more efficient steering guidance performance.

### SUMMARY OF THE DISCLOSURE

According to an aspect of the present disclosure, a brake assist system is disclosed for assisting the steering operations of a mobile vehicle. The brake assist system comprises a service brake assembly comprising a first brake device and a second brake device. An auxiliary control assembly coupled to the service brake assembly, the auxiliary control assembly comprising a main valve circuit and a secondary valve circuit fluidly coupled to an auxiliary supply source. An electronic control unit communicatively coupled to the auxiliary control assembly, wherein the electronic control unit is configured to receive an input signal indicative of a vehicle operating parameter comprising at least one of a steering angle generated by a vehicle guidance system or a vehicle speed error and generate a control signal to activate the main and secondary valve circuits, wherein activation of the main and secondary valve circuits includes proportionally controlling an output of at least two control valves arranged in the main and secondary valve circuits to supply a pressurized flow of fluid is applied to at least one of the first or second brake devices to assist steering operations of the vehicle.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 is a block diagram of a brake assist system according to an embodiment;

FIG. 1A is a schematic illustration of a primary control assembly of the brake assist system of FIG. 1 according to an embodiment;

FIG. 1B is a schematic illustration of an auxiliary control assembly of the brake assist system of FIG. 1 according to an embodiment;

FIG. 1C is a schematic illustration of a service brake assembly of the brake assist system of FIG. 1 according to an embodiment;

FIG. 2 is a side view of a work machine according to an embodiment in which the brake assist system of FIG. 1 is used;

FIG. 3 is a schematic illustration of a wheel axle assembly of the work machine of FIG. 2 according to an embodiment; and

FIG. 4 is a flow diagram of a method for controlling the brake assist system of FIG. 1.

### DETAILED DESCRIPTION OF THE DRAWINGS

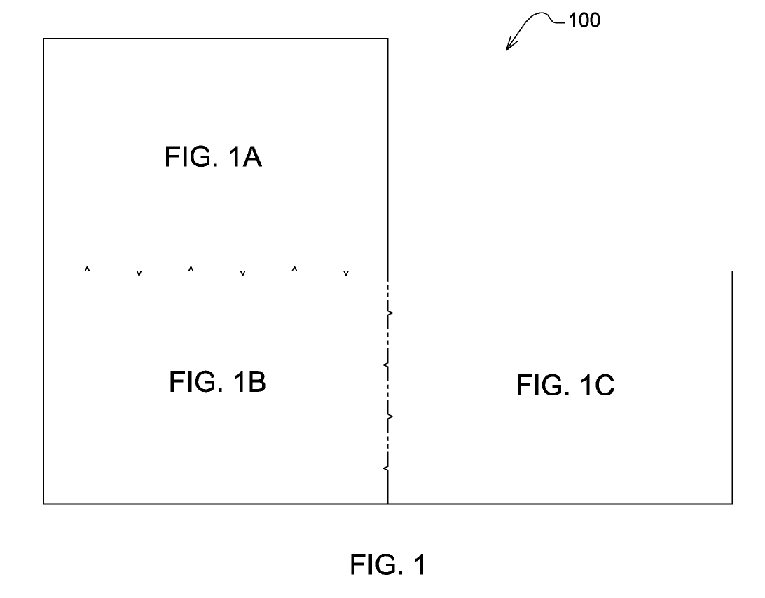

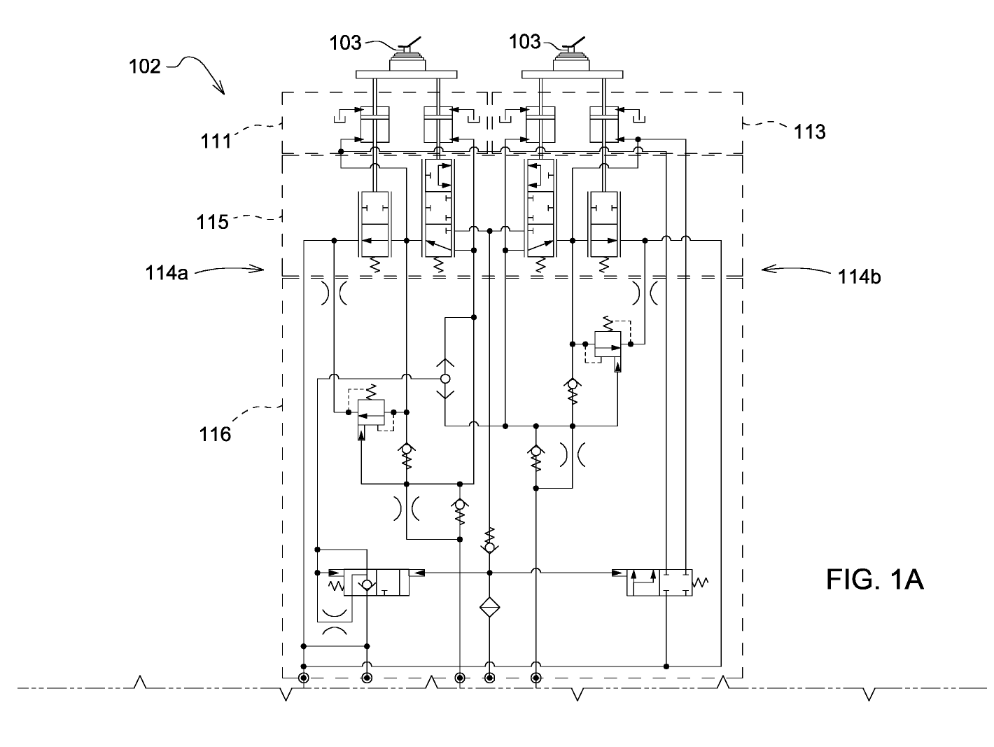

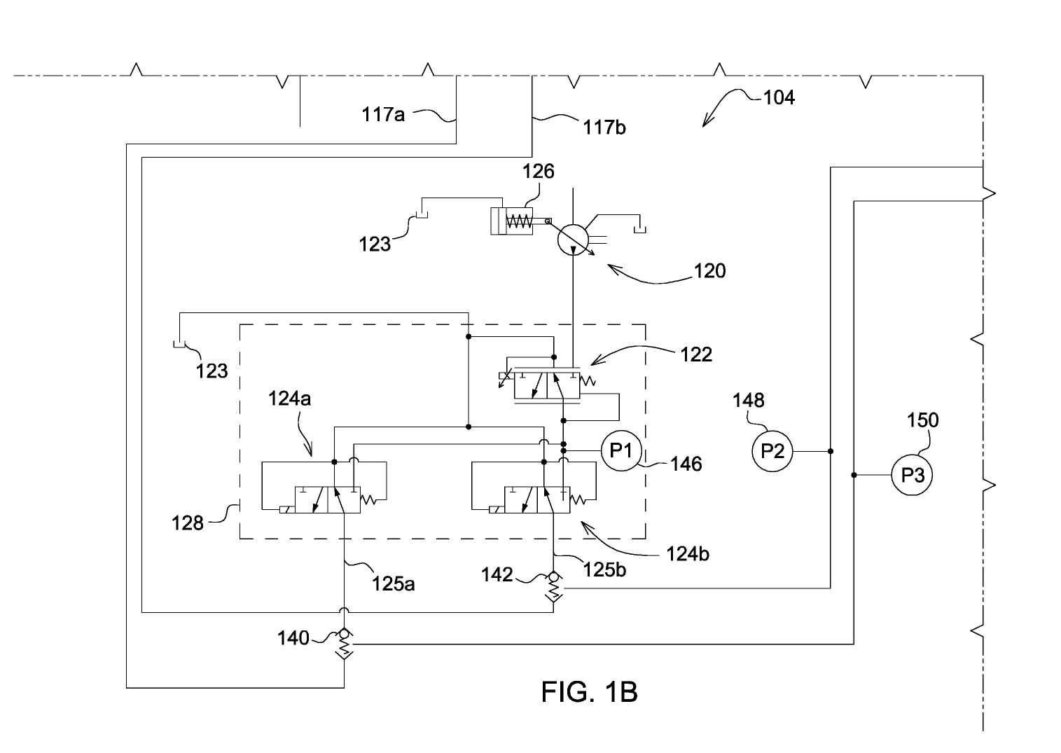

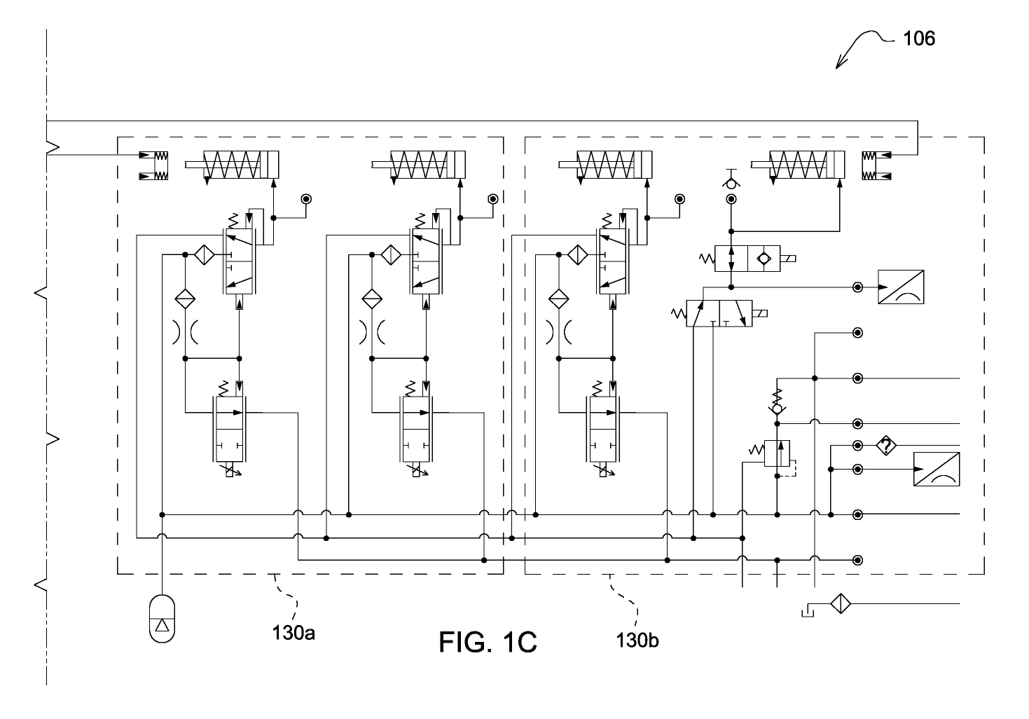

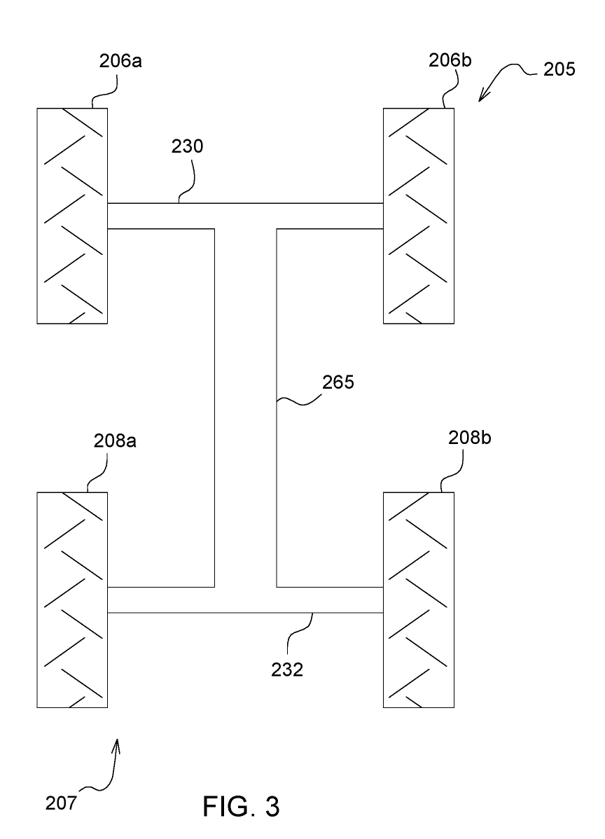

Referring to FIGS. 1, 1A, 1B, and 1C, a brake assist system 100 is shown according to an embodiment. In embodiments, the brake assist system 100 can comprise a primary control assembly 102 and an auxiliary control assembly 104 hydraulically coupled to at least one service brake assembly 106. The service brake assembly 106 can comprise a left service brake 130a and a right service brake 130b that is hydraulically applied and spring released and included as part of a transmission assembly or separately mounted in a drivetrain system of a work machine 200 (refer, e.g., to FIG. 3).

The primary control assembly 102 can comprise at least one foot operated control mechanism 103 coupled to a primary hydraulic circuit 110 to allow for manual activation of the left or right service brake 130a, 130b via an operator input (e.g., foot engagement of pedal). In some embodiments, the primary hydraulic circuit 110 can comprise cylinders 111, 113 arranged in pairs and respectively associated with a corresponding control valve assembly 114a, 114b. Each control valve assembly 114a, 114b can comprise a first and a second valve circuit 115, 116 collectively arranged to define a first and a second primary supply line 117a, 117b that supplies pressurized fluid to the left and right service brakes 130a, 130b. In various embodiments, the first and second valve circuits 115, 116 can comprise a plurality of control valves, including, but not limited to, blocker valves, pilot valves, relief valves, or combinations thereof that are arranged to control the flow of pressurized fluid supplied to service brakes 130a, 130b. For example, as illustrated in FIG. 1A, the primary hydraulic circuit 110 is arranged such that engagement of the at least one foot operated control mechanism 103 activates at least one of cylinders 111, 113, thereby increasing the pressure of fluid in the respective first and second primary supply lines 117a, 117b via control valves arranged in valve circuits 115, 116.

The auxiliary control assembly 104 (FIG. 1B) can comprise an auxiliary valve circuit 128 coupled to an auxiliary supply source 120 and is arranged to provide service brake assist to brake assist system 100. An auxiliary steering cylinder 126 can be arranged upstream of the auxiliary supply source 120 and can be configured to control displacement of the auxiliary supply source 120.

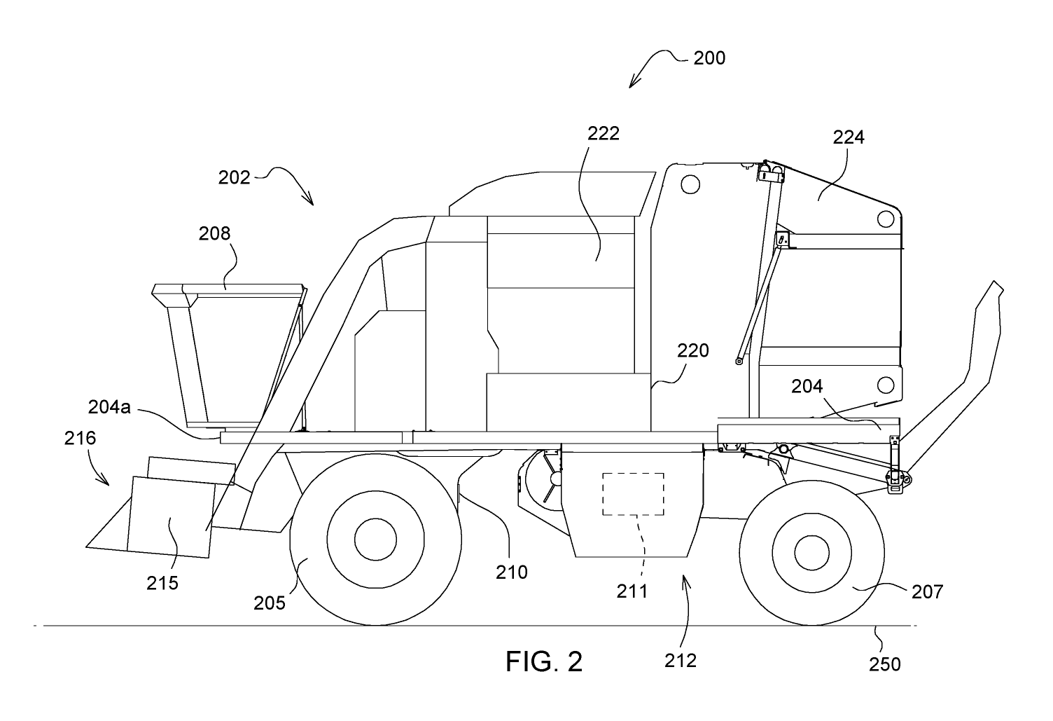

The auxiliary valve circuit 128 can comprise a main auxiliary valve 122 coupled to at least two secondary auxiliary valves 124a, 124b to define a first and a second auxiliary supply line 125a, 125b. Each valve 122, 124a, and 124b can be communicatively coupled to and controlled by an electronic control unit 211 housed within a power module 212 as will be discussed with reference to FIGS. 2 and 3. As depicted, in some embodiments, the main auxiliary valve 122 can comprise a variable pressure valve operatively coupled to the auxiliary supply source 120 at an inlet and to each of the secondary auxiliary valves 124a, 124b at an outlet. Additionally, a return port of each valve 122, 124a, and 124b can be fluidly coupled to a reservoir 123 that is arranged to receive unused fluid drained from each of the first and second supply lines 125a, 125b.

The main auxiliary valve 122 can be arranged to modulate the available pressure from the auxiliary supply source 120 to each of the secondary auxiliary valves 124a, 124b such that adequate fluid and pressure levels are maintained when supplying fluid to service brakes 130a, 130b. In embodiments, the main and secondary valves 122, 124a, 124b can comprise electrohydraulic pressure valves or other suitable control valves. For example, the main auxiliary valve 122 can comprise a variable pressure valve that is arranged to regulate pressure at the valve inlet to maintain an appropriate pressure level. Each of the secondary auxiliary valves 124a, 124b can comprise selector valves or similar devices.

A first and a second shuttle valve 140, 142 can be arranged downstream of the primary and auxiliary control assemblies 102, 104 to allow for selective activation of the left or right service brake 130a, 130b via either the primary control assembly 102 or the secondary control assembly 104. In various embodiments, the first and second shuttle valves 140, 142 can comprise shuttle valves, for example, which are arranged to provide unidirectional flow and to prevent the backwards flow of fluid in the primary and auxiliary supply lines 117a, 117b and 125a, 125b.

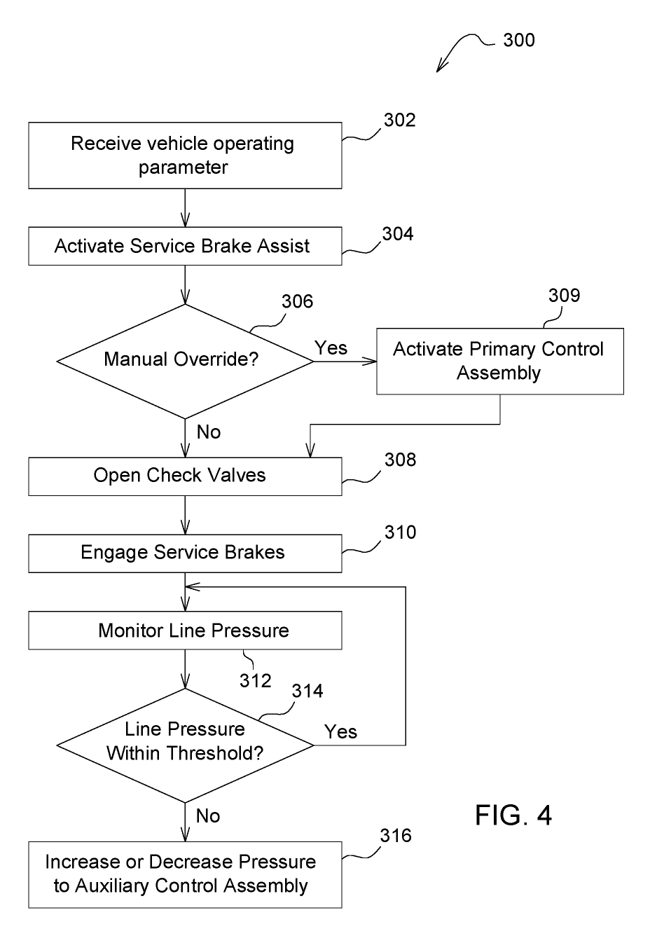

As depicted in FIGS. 1A-1C, the brake assist system 100 can further comprise a plurality of pressure sensors 146, 148, 150 arranged at various locations within the brake assist system 100 in embodiments. For example, a first pressure sensor 146 can be arranged to monitor a pressure difference between the main auxiliary valve 122 and the secondary auxiliary valves 124a, 124b. A second and third pressure sensor 148, 150 can be arranged following each of the shuttle valves 140, 142 to indicate the pressure being applied to the left or right service brake 130a, 130b from the individual or combined pressure sources. For example, the first, second, and third pressure sensors 146, 148, 150 can be leveraged to support the control strategy for the applied pressure to one or both service brakes 130a, 130b and to provide diagnostic capability as will be discussed with reference to FIG. 4.

With respect to FIGS. 1, 1A, 1B, and 1C, it will be appreciated by those skilled in the art that FIGS. 1, 1A, 1B, and 1C are not drawn to scale and are for illustrative purposes only to demonstrate exemplary embodiments of the present disclosure. Notably, the structural layout and quantity of the various components can and will vary in other embodiments. For example, as discussed above, in some embodiments, the brake assist system 100 can optionally comprise one or more pressure sensors. Additionally, in other embodiments, the brake assist system 100 can comprise fewer or more control devices or brake components (e.g., valves 122, 124 or brakes 130) based on design and/or application requirements.

Referring now to FIGS. 2-3, a work machine 200 in which the brake assist system 100 of FIG. 1 is implemented is shown. The work machine 200 can comprise a harvester 202 (e.g., cotton harvester or combine) such as that illustrated in FIG. 2 in some embodiments, but may vary in other embodiments. In other embodiments, work machine 200 can include tractors or other suitable tracked or wheeled vehicles specific to application and design requirements. The harvester 202 can comprise a body frame 204 supported by forward wheels 205 and rear wheels 207 for movement through a field 250. An operator cab 208 can be arranged in an upright position on a forward portion 204a of the body frame 204 forwardly of a front axle support 210 which extends downwardly from the forward portion 204a and supports the forward and rearward wheels 205, 207.

In embodiments, a harvesting structure 216 can be coupled to the forward portion 204a of the body frame 204 and arranged to extend outwardly and away from the body frame 204. As depicted, in some embodiments, the harvesting structure 216 can comprise one or more cotton picking units 215, a cotton stripper header, or other suitable harvesting structures (e.g., corn head or sugarcane harvesters), which are arranged to engage a surface of the field 250 for removal of crops such as cotton or grains. In the example embodiment, a feeder 220 can additionally be coupled to the body frame 204 and is arranged to receive cotton, or other crops, from an accumulator 222 as the crop is removed from the field 250. The accumulated crop is then compressed by and transferred from the feeder 220 to a baler 224 for bundling.

As shown in further detail in FIG. 3, the forward wheels 205 can comprise a left front drive wheel 206a and a right front drive wheel 206b, which can be tracked or non-tracked. Similarly, the rear wheels 207 can comprise a left rear drive wheel 208a and a right rear drive wheel 208b. Each of the left and right wheels (i.e., front and rear drive wheels 206a/208a and 206b/208b) can be equidistantly spaced from a center line 265 of the harvester 202. A forward axle 230 is coupled to the front drive wheels 206a and 206b, and similarly, a rear axle 232 is coupled to the rear drive wheels 208a and 208b. In various embodiments, the forward and rear wheels 205, 207 can be powered or non-powered, and are arranged to guide the work machine 200 over the field 250. Referring now back to FIG. 2, the power module 212 can be supported below the body frame 204 and can comprise an engine (not shown) housed within the power module 212 for powering the drive train and other systems of the harvester 202. For example, in embodiments in which the forward or rearward wheels 205, 207 are powered, each wheel can be driven by a motor that is powered by the power module 212.

Referring to FIG. 4, a flow diagram of a method 300 for applying service brake assist via the brake assist system 100 is shown. At 302, a vehicle operating parameter is received by the electronic control unit 211, which can be received via an operator interface or a control signal to activate the auxiliary control assembly 104. In some embodiments, the vehicle operating parameter can comprise a steering angle, which is received as an input by the electronic control unit 211 to determine a corresponding amount of service brake to be applied to assist with the steering operations. Once received, the commanded steering angle is compared against data stored in a look-up table to determine the required amount of service brake application (e.g., amount of pressure or valve opening) at 304. For example, the value of the commanded steering angle is proportional to the amount of pressure (i.e., the higher the steering angle in a certain direction, the higher the applied pressure) that could be applied to either of the corresponding left or right service brakes 130a, 130b to assist the vehicle in making a turn in the same direction.

In other embodiments, such as in vehicle guidance systems (e.g., mechanical row sensing or satellite guidance systems), the steering angle can be determined based on a position error of the work machine 200. The position error, similar to the steering angle, could also be used as an input into a look-up table to determine the required amount of service brake application. In guidance systems such as John Deere RowTrak or AutoTrak, the position error could be used to provide an additional output of service brake application to assist the steering axle in making the position correction of work machine 200 when it has deviated from a preferred path. For example, as the vehicle guidance system commands a steering angle of the steering axle based on the position error, the guidance system could generate an output signal to control the amount of service brake application to the left or right service brake 130a, 130b. This is particularly advantageous to help facilitate driving in inclement weather and/or poor traction conditions (e.g., wet or muddy harvest conditions) where vehicle guidance is desired, but the difficulty of obtaining correct responses from the steering axle is significantly increased or no longer possible due to poor guide wheel traction.

Additionally, in contrast to conventional systems, where manual application of the service brakes disengages the vehicle guidance system and requires manual steering of the vehicle in inclement weather conditions, the present disclosure overcomes such limitations by permitting simultaneous engagement of both the primary control assembly 102 and the vehicle guidance system. For example, if inclement weather conditions exist, rather than disengaging the vehicle guidance system and allowing an operator to control the work machine 200 manually via the primary control assembly 102, steering operations are controlled automatically via the auxiliary control assembly 104 while the guidance system remains engaged.

In yet other embodiments, the vehicle operating parameter can further comprise a vehicle speed value (e.g., a calculated error between an actual and a commanded vehicle speed). For example, in panic stop situations where an operator commands a quick deceleration through a hydro handle actuation or other control means and hydrostatic braking or engine braking is limited or not possible, the electronic control unit 211 will activate the auxiliary control assembly 104 to engage at least one of service brakes 130a, 130b. This in turn, assists in deceleration of the work machine 200 and helps to prevent downstream drivetrain and pump over-speed by limiting the amount of engine over-speed. Such protection is advantageous in that it allows for optimal sizing of pumps (e.g., supply source 120) for rated and below rated speed performance without the concern of over-speed.

In yet other embodiments, instead of using the steering angle or the vehicle speed, direct hydraulic feedback could be used as the input signal to the electronic control unit 211 for activating the auxiliary control assembly 104.

As discussed above, once the vehicle operating parameter is received, the electronic control unit 211 generates an output signal that activates the auxiliary control assembly 104 at 304. For service brake assist to occur, at least two valves (i.e., the main auxiliary valve 122 and at least one of the secondary auxiliary valves 130a, 130b) must be actuated, which serves as a safety interlock, to prevent inadvertent application of the auxiliary control assembly 104. Upon activation, the main auxiliary valve 122 modulates the available pressure from the auxiliary supply source 120 to allow flow to pass through the secondary auxiliary valves 130a, 130b, which are arranged to control the flow of fluid in supply lines 125a, 125b (i.e., an increase or decrease in fluid supplied to shuttle valves 140, 142).

Next at 308, shuttle valves 140, 142 are opened to supply the pressurized fluid to either or both of service brakes 130a, 130b to exert a corresponding braking force on the service brakes 130a, 130b (i.e., engage service brakes) associated with either the forward or rear wheels 205, 207 at 310. The braking force is proportional to the applied pressure and degree of opening of the valves 122, 124a and/or 124b. In some embodiments, the automatic engagement of the service brakes 130a, 130b via the auxiliary control assembly 104 can be overwritten via an operator input at 304. For example, if a vehicle operator chooses to disengage the auxiliary control assembly 104, an override control signal is sent to the electronic control unit 211 at 309 to activate the primary control assembly 102 and deactivate the auxiliary control assembly 104.

As previously discussed with reference to FIGS. 1A-1C, to ensure the correct amount of pressure is maintained, at 312 and 314, the electronic control unit 211 receives signals from each of pressure sensors 146, 148, and 150 to monitor the line pressure and outputs a control signal to auxiliary supply source 120 and valves 124a, 124b to increase or decrease the supplied flow of fluid. For example, in response to receipt of the pressure feedback signal, the electronic control unit 211 can alert operator via an operator interface by generating a warning signal or by sending a control signal to the primary and auxiliary valves 122, 124a, and 124b to increase or decrease a degree of opening or closing at 316. In this way, the system 100 is able to respond more quickly and efficiently.

Without in any way limiting the scope, interpretation, or application of the claims appearing below, a technical effect of one or more of the example embodiments disclosed herein is a system and method for automatically applying service brakes to assist with the steering operations of a mobile vehicle. The present disclosure is particularly advantageous in that it optimizes machine performance by offering service brake assist steering to vehicles with non-powered axles which allows for axles to be closer to the turning and to more precisely replicate the steering ability of a powered rear axle.

While the above describes example embodiments of the present disclosure, these descriptions should not be viewed in a limiting sense. Rather, other variations and modifications may be made without departing from the scope and spirit of the present disclosure as defined in the appended claims.

1. A brake assist system for assisting the steering operations of a mobile vehicle, the brake assist system comprising:
a service brake assembly comprising a first brake device and a second brake device;
an auxiliary control assembly coupled to the service brake assembly, the auxiliary control assembly comprising a main valve circuit and a secondary valve circuit fluidly coupled to an auxiliary supply source; and
an electronic control unit communicatively coupled to the auxiliary control assembly, wherein the electronic control unit is configured to receive an input signal indicative of a vehicle operating parameter comprising at least one of a steering angle generated by a vehicle guidance system or a vehicle speed error, and generate a control signal to activate the main and secondary valve circuits, wherein activation of the main and secondary valve circuits comprises proportionally controlling an output of at least two control valves arranged in the main and secondary valve circuits to supply a pressurized flow of fluid to at least one of the first or second brake devices to assist steering operations of the vehicle.

2. The brake assist system of claim 1, wherein the main valve circuit comprises at least one pressure control valve that is configured to modulate an available pressure from the auxiliary supply source.

3. The brake assist system of claim 1, wherein the auxiliary supply source comprises a pressurized source of hydraulic fluid.

4. The brake assist system of claim 1 further comprising a primary control assembly coupled to at least one foot operated control mechanism.

5. The brake assist system of claim 4 further comprising at least two shuttle valves arranged downstream of the primary control assembly and the auxiliary control assembly, wherein each of the at least two shuttle valves is configured to selectively switch between a manual operation and an automatic operation of the service brake assembly based on a user input.

6. The brake assist system of claim 5, wherein the manual operation of the service brake assembly is activated via the primary control assembly, and wherein the automatic operation of the service brake assembly is activated via the auxiliary control assembly.

7. The brake assist system of claim 6, wherein the manual operation of the service brake assembly is activated simultaneously with the vehicle guidance system and steering operations are controlled via the auxiliary control assembly when an inclement weather and/or poor traction condition is sensed.

8. The brake assist system of claim 1, wherein the vehicle operating parameter is correlated to a predetermined pressure value stored in a look-up table.

9. The brake assist system of claim 1 further comprising at least one pressure sensor, wherein the at least one pressure sensor is configured to output a signal indicative of a measured pressure that is fed back into the electronic control unit to adjust an output of at least two valves arranged in the auxiliary control assembly based on the measured pressure.

10. A method for assisting steering operations of a vehicle, the method comprising:
receiving, by an electronic control unit, an input signal corresponding to a vehicle operating parameter indicative of a steering angle generated by a vehicle guidance system;
correlating, by the electronic control unit, a predetermined pressure value with the vehicle operating parameter; and
providing steering assist to the vehicle by proportionally controlling an output of at least two control valves arranged in an auxiliary control assembly to supply a pressurized flow of fluid to at least one of a first brake device or a second brake device arranged in a service brake assembly to assist steering operations of the vehicle.

11. The method of claim 10, wherein correlating the predetermined pressure value with the vehicle operating parameter comprises associating the vehicle operating parameter with a value stored in a look-up table to obtain the predetermined pressure value.

12. The method of claim 11, wherein the vehicle operating parameter further comprises a vehicle speed error value.

13. The method of claim 10, further comprising dynamically adjusting an amount of pressurized fluid applied to the first or second brake device based on a sensed pressure change in a first or second pressure feedback line.

14. The method of claim 10, wherein the auxiliary control assembly comprises a main valve circuit and a secondary valve circuit comprising a plurality of control valves arranged to control the pressurized flow of fluid.

15. The method of claim 10 further comprising receiving, by the electronic control unit, an override control signal configured to deactivate the auxiliary control assembly and to activate a primary control assembly to allow for manual operation of the service brake assembly via at least one foot operated control mechanism.

16. The method of claim 10 further comprising receiving, by the electronic control unit, an override control signal configured to prevent deactivation of the vehicle guidance system and the auxiliary control assembly when a primary control assembly is activated during a sensed inclement weather and/or poor traction condition.

17. The method of claim 10, wherein providing steering assist to the vehicle further comprises controlling the vehicle in the event of a detected offset to provide for increased operating guidance speed.
